(19) United States
(12) Patent Application Publication
(10) Pub. No.: US 2024/0400300 A1
(43) Pub. Date: Dec. 5, 2024

(54) WASTE BIN WITH PEDAL-OPERATED SWIVEL LID

(71) Applicant: Rotho Kunststoff AG, Wurenlingen (CH)

(72) Inventors: Bruno Meier, Untersiggenthal (CH); Christian Thoma, Albbruck (DE)

(73) Assignee: Rotho Kunststoff AG, Wurenlingen (CH)

(21) Appl. No.: 18/734,334

(22) Filed: Jun. 5, 2024

(30) Foreign Application Priority Data
Jun. 5, 2023 (EP) 23177297.1
Jan. 4, 2024 (EP) 24150357.2

(51) Int. Cl. B65F 1/16

(52) U.S. Cl. CPC B65F 1/163; B65F 2250/114

(57) ABSTRACT

A waste bin with a pedal-operated swivel lid, in which a pedal is located in a bottom region, on a front side of said waste bin, which pedal is connected via a lever mechanism to a pull element, in particular to a pull strap. The pull element runs on a rear side of the waste bin from its bottom region to the swivel lid and produces an operative connection between the pedal and the swivel lid. The pedal is arranged extendably on the waste bin in such a way that, in a first, pushed-in position, it does not protrude beyond the front side of the waste bin, and, in a second, extended position, it protrudes beyond the front side of the waste bin and is operatively connected to the lever mechanism in such a way that stepping upon the pedal 3 opens the swivel lid.

### CROSS-REFERENCE TO RELATED APPLICATIONS

This application claims priority from European Patent Application No. EP23177297.1, filed Jun. 5, 2023, and European Patent Application No. EP24150357.2, filed Jan. 4, 2024, both of which are incorporated herein by reference as if fully set forth.

### TECHNICAL FIELD

The invention relates to a waste bin with a pedal-operated swivel lid. This involves a plastics waste bin, the swivel lid of which is normally also composed of plastic, with the production expediently being carried out by means of plastics injection molding.

### BACKGROUND

Accordingly, a waste bin of the present type has, in a bottom region, on a front side of said waste bin, a pedal which is connected via a lever mechanism to a pull element, in particular a pull rod or a pull strap. Said pull element runs on a rear side of the waste bin from its bottom region to a rear side of the swivel lid and produces an operative connection between the pedal and the swivel lid. The swivel lid is attached via a hinge to a container body, specifically to the rear side of the container body, in an upper edge region thereof, wherein the rear side of the swivel lid protrudes beyond the hinge, more precisely: to the rear over the container body beyond an axis of the hinge as far as a starting point for the pull element. In one of the two variants of the invention, the swivel lid may also consist of two (or more) swivel lid parts.

Waste bins with a pedal-operated swivel lid have been known for many years. In particular in the case of waste bins made of metallic materials, the connection between the pedal and the swivel lid is usually produced by means of a push rod, which pushes the swivel lid upward when the pedal is stepped upon and pivots said swivel lid open. For this purpose, the pedal is mounted in the bottom region of the waste bin in the manner of a rocker. When the pedal or a pedal section oriented toward the front side of the waste bin is stepped upon, it moves downward, as a result of which an actuating section of the pedal oriented toward the rear side of the waste bin shifts upward in the manner of a rocker, thereby pushing the push rod upward to open the swivel lid.

In particular in the case of waste bins which are equipped with a pedal-operated swivel lid and are intended for larger households or for professional use, it has been common for some time now to produce them from injection-molded plastics material instead of metallic materials, for weight and cost reasons. Since a push rod made of plastic has to be constructed quite voluminously in order to have the stability required for a push rod, a steel rod is usually still used for the push rod of a waste bin with a pedal-operated swivel lid.

Alternatively, it is known to change the lever mechanism on the pedal such that, instead of a push rod, a pull element can be used for the operative connection between the pedal and the swivel lid. A pull element has the advantage, especially when it is in the form of a pull strap, that it can be easily produced from plastic and can even be attached via film hinges to the components to be connected. In addition, a pull element can more easily be guided upward outside the waste bin to the swivel lid, since the pull element acts on the swivel lid behind the hinge thereof to open said swivel lid, whereas a push rod pushes the swivel lid upward in front of the hinge, and therefore the push rod often runs in a recess of the waste bin, as seen in projection within its surface area, and accordingly prevents a smooth-walled rear wall of the waste bin.

Plastics waste bins with a pedal-operated swivel lid are very light in relation to their volume, and therefore the decisive criterion for the cost of transport is not weight, but the volume. It is therefore of the utmost importance that a plurality of waste bins can be placed one inside another, i.e. nested together, for transport, in order to significantly reduce the overall volume.

The waste bins as such are usually—if they have been produced by plastics injection molding, necessarily—manufactured slightly conically so that they can easily be nested together. However, the problem here is the pedal for operating the swivel lid, since it usually protrudes beyond the front side of the waste bin in order to be easily activated. This protruding pedal does of course prevent the nesting capability of the waste bin equipped with it.

In order to solve this problem, in WO 2016/110858 A9, in the case of a waste bin of the type mentioned at the beginning, it has been proposed to integrate the pedal in the bottom region of the waste bin in such a way that it does not protrude beyond the front side thereof. Instead, a large-volume recess is provided in the bottom region of the waste bin, on the front side thereof, within which the pedal or its front pedal section is arranged. The recess makes available a foot space for a user, in which the user can insert their foot and can then operate the pedal by stepping downward thereon. The fact that the pedal does not protrude beyond the front side of the waste bin with any of its parts because of this arrangement does not affect its nesting capability. However, many users consider it unfavorable if the pedal for operating the swivel lid does not protrude beyond the front side of the waste bin. In addition, the volume of the recess is absent in the interior of the container body.

Irrespective of whether the waste bin, as is preferred here, is manufactured from plastic or is composed of other materials, it is sometimes unfavorable that the container body has a fixedly specified volume and is suitable only for garbage bags with a volume matched thereto.

An adaptability of the usable container volume is desirable, for example, if the number of people using the waste bin fluctuates seasonally, for example in shared student accommodation, or if, when garbage separation is practiced, the volumes of the individual garbage fractions, such as packaging waste and bio-waste, differ, but, for visual reasons, the individual waste bins are intended to be identical in size. Finally, it is often expedient to be able to increase the usable volume of a waste bin as the situation requires, for example, if there are visitors in the household or, as is regularly the case, for example, in Christmas holidays, the volume of garbage is significantly increased for a short period of time.

### SUMMARY

In the first variant, the present invention relates to a waste bin which is equipped with a pull element for actuating the swivel lid. In the second variant, a push rod can also be provided for actuating the swivel lid.

Starting from the above-mentioned prior art, it is the object of a first variant of the present invention to improve the usability of a waste bin of the type mentioned at the beginning without impairing its nesting capability.

It is the object of a second variant of the present invention, in view of the above-mentioned prior art, to develop a waste bin of the type mentioned at the beginning in such a way that its usable volume can be reduced as required in an easily handleable way, by also using garbage bags, the volume of which is smaller than the actually usable volume of the waste bin.

The first object is achieved by a waste bin having one or more of the features described herein for a waste bin with a pull element for actuating the swivel lid. Preferred refinements and developments of the waste bin according to the invention are described below and in the claims.

The second object is achieved by a waste bin having one or more of the features for a waste bin with a usable volume can be reduced. Preferred refinements and developments of said waste bin according to the invention are described below and in the claims.

The waste bin according to the invention produced from plastic with a pedal-operated swivel lid therefore has, as is known per se from the prior art, in a bottom region, on a front side of said waste bin, a pedal which is connected via a lever mechanism to a pull element, which pull element runs on a rear side of the waste bin from its bottom region to a rear side of the swivel lid and produces an operative connection between the pedal and the swivel lid, the swivel lid being attached to a container body via a hinge on the rear side of the container body of the waste bin, in an upper edge region of said container body, and the rear side of the swivel lid protruding beyond the hinge to the rear as far as a starting point for the pull element. In order to achieve the aforementioned object of the first variant of the invention, the pedal, in contrast to the prior art, is arranged extendably on the waste bin, specifically in such a way that, in a first, pushed-in position, it does not protrude beyond the front side of the waste bin, and, in a second, extended position, it protrudes beyond the front side of the waste bin and is operatively connected to the lever mechanism in such a way that stepping upon the pedal opens the swivel lid.

By means of the extendability according to the invention of the pedal, advantages are thus achieved both in the transport of the waste bin and in its use: for transport, the pedal is in the first, pushed-in position and thus does not protrude beyond the front side of the waste bin, and therefore it does not in any way impair the nesting capability of the waste bin. For use of the waste bin, the pedal is extended until, in its second, extended position, it protrudes beyond the front side of the waste bin and ensures that stepping upon the pedal results in the opening of the swivel lid. This makes the operation highly intuitive, the pedal is very easily accessible for a user's foot, and the volume for a recess for forming a foot space above the pedal, as has been proposed in the prior art, is ultimately also not absent in the usable volume of the waste bin.

The pull element of the waste bin according to the invention is preferably composed of plastic and is preferably in the form of a pull strap. Particularly preferably, the pull element is connectable to the swivel lid via an upper film hinge and/or is connectable to the lever mechanism via a lower film hinge. The production of the pull element from plastic results in weight and cost advantages, the latter being particularly noticeable when the articulated connection between the pull element and the swivel lid or between the pull element and the lever mechanism is brought about with a respective film hinge which, as is known, is produced in the same injection molding process as the pull element, i.e., together therewith. This is particularly cost-effective if the pull element is in the form of a pull strap.

If the pull element is provided with an upper film hinge, it is advantageous if an upper latching element is integrally formed on the pull element via the film hinge, the upper latching element being used for latching in a recess provided for this purpose in the swivel lid. In a corresponding manner, the pull element, if it has a lower film hinge, is preferably fixedly connected integrally via said film hinge to a lower latching element, which is used for latching in the lever mechanism.

In both cases, the pull element is intuitively and easily connectable to the lever mechanism, on the one hand, and to the swivel lid, on the other hand. This makes it possible, for transport of the waste bin according to the invention, first of all not yet to attach the pull element to the waste bin, but rather to fit it only immediately before use of the waste bin. The intuitive and simple, preferred latching connections mean that this can ultimately also be left to the end customer.

If the pull element does not have to be fitted for transport, further advantages in the nesting capability of the waste bin are afforded; because, in the fitted state, the pull element in the upper region of the container body has to be to a certain extent at a distance away from the latter in order to reach the starting point on the rear side of the swivel lid.

If the swivel lid initially does not sit fixedly in its hinge, but rather may be inserted into the waste bin prior to the use thereof, the transportability of the waste bin according to the invention is optimized even further.

Irrespective of whether the pull element is in the form of a pull strap and/or is manufactured from plastic and is optionally provided with film hinges, said pull element of the waste bin according to the invention is preferably guided in the rear side of the waste bin in a groove, in particular in an at least partially covered recess in the container body, as a result of which it is not only protected during use, but in particular also during transport, where it is less likely to interfere with the nesting capability of the waste bin according to the invention.

A guide element which guides the pull element in the groove can also be provided in an upper region of the groove. In particular if the pull element is configured in the form of a pull strap, it can be highly advantageous both during transport and during use of the waste bin if the guide element deflects the pull element from the groove to the starting point on the swivel lid. The pull strap then runs as far as the guide element entirely in the groove and is protected by the latter.

The lever mechanism of the waste bin according to the invention is particularly preferably designed in such a way that the pedal, in its second, extended position, in the bottom region of the waste bin is mounted rotatably in the manner of a rocker in a pedal bearing point, with a pedal section which is oriented from the bearing position to the front side of the waste bin and protrudes beyond said front side, and with an actuating section which is oriented from the bearing point to the rear side of the waste bin, wherein preferably two bearing journals integrally formed on both sides of the pedal are used for mounting the pedal in the pedal bearing point.

In this case, the lever mechanism, in addition to the pedal, comprises a rocker which is mounted rotatably in a rocker bearing point and serves for the operative connection of the pedal to the pull element, i.e., converts a movement of the pedal, upon the latter being stepped upon, into a movement, in this case into a pulling movement, of the pull element. This rocker is connected in a rear rocker section to the pull element in a manner resistant to tension, in particular via a film hinge and particularly preferably by means of a latching connection, and a front rocker section is arranged above the actuating section of the pedal—at least if the latter is in its second, extended position—in order to be moved upward by said actuating section when the pedal section is stepped upon. This movement upward leads to a movement of the rear rocker section downward because of the mounting of the rocker in the rocker bearing point, and therefore the rear rocker section pulls the pull element with it downward and thereby opens the swivel lid.

Provision may be made here for the dead weight of the swivel lid to lead to the pull element pulling the rear rocker section upward, and thus the front rocker section downward, in order to move the actuating section of the pedal back downward and thus the pedal section back upward into its starting position. According to the invention, it has been recognized that, for this purpose, a fixed connection between the front rocker section and the actuating section of the pedal is not necessary; it is sufficient if these two components are arranged one above the other in the second position of the pedal (rocker section at the top and actuating section at the bottom).

It is even preferred, within the scope of the present invention, if the pedal and the rocker are not fixedly connected to each other, since this allows the pedal to be moved very easily from the first into the second position without having to change anything on the rocker or any other parts of the lever mechanism. This preferred refinement allows the pedal, despite the presence of a pull element and thus the need for a relatively complex lever mechanism, to be able to be very easily pushed into the first position or extended into the second position.

By means of a depression in the actuating section of the pedal, which the front rocker section can enter when the pedal is not yet in its second, extended position, it can be ensured that the rocker has sufficient clearance to allow the extension movement of the pedal even when the pull element is already fitted. Especially if the end customer is left to assemble the waste bin, it is of great advantage if there is no need to specify a fixed sequence of the assembly steps.

For extending the pedal from the first into the second position in order to make the waste bin according to the invention ready for use—but, if desired, also for pushing-in the pedal again—it is preferred if the pedal can be moved in a slotted guide from the first into the second position, and optionally also vice versa. The slotted guide is expediently provided here for guiding pedal bearing journals arranged on both sides of the pedal, and it expediently also forms the pedal bearing point, into which the two pedal bearing journals are moved when the pedal is extended.

Expediently, the pedal latches at least in the second, extended position, which in the case of existing pedal bearing journals and a slotted guide with a pedal bearing point can be easily brought about by the fact that the pedal bearing point for receiving the pedal bearing journals in the profile describes not only a semicircle, but a little more than a semicircle, and therefore the pedal bearing journals can be pressed into the pedal bearing points only against elastic deformation of the slotted guide and can thus latch there.

Alternatively, or in addition, at least one latching element can also be provided which prevents movement of the pedal from the second, extended position back into the first, pushed-in position as soon as the pedal has been moved into the second, extended position. Thus, two embodiments can be provided, in which pushing-in again of the pedal is possible in one case and is impossible in the other case.

Such a latching element is preferably in the form of a catch which latches behind the pedal bearing journal when the second, extended position of the pedal is reached. Said catch is preferably formed by an elastically deformable latching element which is integrally formed on the slotted guide.

According to another preferred refinement of the waste bin according to the invention, a trough-shaped insert element is provided for inserting into the bottom region of the waste bin and for covering the lever mechanism. Preferably, this trough-shaped insert element sits removably in the container body and can be inserted optionally in a reverse orientation into the latter. This has the great advantage that the effective bottom of the waste bin can thereby be very easily moved upward, and therefore garbage bags with a smaller volume than the actual volume of the waste bin do not hang in the air and run the risk of tearing through at the bottom or of tearing off at the top, but rather are supported by the raised bottom as they gradually fill.

According to a further preferred refinement of the waste bin according to the invention, a frame is provided for hanging garbage bags in the upper edge region of the container body, wherein said frame is composed of a front frame part and a rear frame part, which are inserted into each other and are adjustable in a latching manner with respect to each other by means of a rack and pinion mechanism. Preferably, the front frame part can be placed here in a form-fitting manner onto an upper edge of the container body. This means that garbage bags of differing size can be fastened to the frame and hung in the waste bin by being placed onto the upper edge of the container body since the frame is adjustable in its circumference, but said frame, owing to its rack and pinion mechanism, maintains the circumference once selected and securely holds the hung garbage bag.

With the preferred form-fitting connection of the front frame part at the upper edge of the container body, the frame can first of all be removed, pushed completely together and then the garbage bag attached to the frame, after which the rear frame part is extended out of the front frame part until the garbage bag is appropriately held in place. Owing to the latching rack and pinion mechanism, the frame then remains in this position and can be placed onto the container body.

For transport of said preferred refinement of the waste bin according to the invention, the frame can preferably be clipped into the swivel lid.

According to the second variant of the present invention, the waste bin according to the invention preferably produced from plastic with a pedal-operated swivel lid has, as is known per se from the prior art, in a bottom region, on a front side of the waste bin, a pedal which is connected via a lever mechanism to a push rod or a pull element, which runs on a rear side of the waste bin from its bottom region to the swivel lid and produces an operative connection between the pedal and the swivel lid, wherein the single- or multi-part swivel lid is attached to a container body of the waste bin via at least one hinge, specifically in an upper edge region of the container body. In order to achieve the object referred to in the second variant, a frame for hanging garbage bags is provided according to the invention in the upper edge region of the container body, wherein said frame consists of a front frame part and a rear frame part which are inserted into each other and are movable in a latching manner against each other in order to change the circumference of the frame by pulling apart or pushing together the frame parts. Furthermore, a trough-shaped insert element is provided for inserting into the container body and optionally for covering the lever mechanism, which insert element sits removably in the container body and is insertable again optionally in a reverse orientation into the container body in order to reduce the usable volume of the waste bin.

The trough-shaped insert element, which is insertable into the container body in two orientations, allows the effective bottom of the waste bin to be very easily moved upward, and therefore garbage bags with a smaller volume than the actual usable volume of the waste bin do not hang in the air and run the risk of tearing through at the bottom or of tearing off at the top, but rather are supported by the raised bottom as they gradually fill.

At the same time, the frame according to the invention for hanging garbage bags, the circumference of which is variable according to the invention, ensures reliable holding of the garbage bag in the waste bin according to the invention, specifically even if the garbage bag is actually too small for the usable volume of the waste bin and cannot lie all around the upper edge region of the container body or can be hung all around same. This is because the frame, which is reduced in size by being pushed together, nevertheless makes it possible to fasten the garbage bag, which is actually too small, all around the upper edge region of the container body by being hung all around the frame.

The combination of a frame for hanging garbage bags with a reducible circumference and a trough-shaped insert element, which can be inserted with reverse orientation into the container body and thereby raises the bottom thereof, thus enables a waste bin according to the invention to be easily usable for garbage bags which are too small for the specified volume of the container body and thus for the actual usable volume of the waste bin, although the functionality of a smaller waste bin for the garbage bags which are actually too small is completely provided in the waste bin according to the invention. With a few simple maneuvers, the waste bin can be converted again as required to provide its full usable volume again.

Preferably, the front frame part and the rear frame part of the frame according to the invention for hanging garbage bags are movable in a latching manner against each other by means of a rack and pinion mechanism. The latching enables the frame to maintain the circumference once selected and securely holds the hung garbage bag without yielding in its circumference as the weight of the garbage bag increases.

It is furthermore preferred if at least the front frame part of the frame for hanging garbage bags can be placed in a form-fitting manner onto an upper edge of the container body and is secured in particular by means of pins or apertures.

With the preferred form-fitting connection of the front frame part at the upper edge of the container body, the frame can first of all be removed, pushed completely together and then the garbage bag attached to the frame, after which the rear frame part is extended out of the front frame part until the garbage bag is appropriately held in place. Owing to the latching rack and pinion mechanism, the frame then remains in this position and can be placed onto the container body.

For transport of said preferred refinement of the waste bin according to the invention, in which the frame can be freely handled, the frame can preferably be clipped into the swivel lid.

Finally, within the scope of the present invention, it is also preferred to provide a damper element for a damped closing movement of the swivel lid, wherein this expediently acts on the rocker, preferably on the rear rocker section, and slows down its movement. By this means, the damper element is protected and is attachable invisibly in the bottom region of the waste bin.

### BRIEF DESCRIPTION OF THE DRAWINGS

An exemplary embodiment for a waste bin according to the invention will be described and explained in more detail below with reference to the accompanying drawings, wherein the description below of the figures is merely by way of example and does not restrict the scope of the invention, but may nevertheless contain features according to the invention.

In the figures:

FIG. 1 shows an isometric illustration of a waste bin configured according to the invention;

FIG. 2 shows an isometric illustration of the waste bin from FIG. 1, as seen from below;

FIG. 3 shows a schematic lateral illustration of parts of the waste bin essential to the invention from FIG. 1;

FIGS. 3A to 3D show the lever mechanism in different mounting and actuating positions;

FIG. 4 shows the bottom region of the waste bin from FIG. 1;

FIG. 5 shows a Figure as per FIG. 4, in which parts essential to the invention are omitted,

FIG. 6 shows a Figure as per FIG. 4, in which further parts essential to the invention are omitted,

FIG. 7 shows a detail on the rear side of the swivel lid of the waste bin from FIG. 1;

FIG. 8 shows a frame for hanging garbage bags in the waste bin.

### DETAILED DESCRIPTION

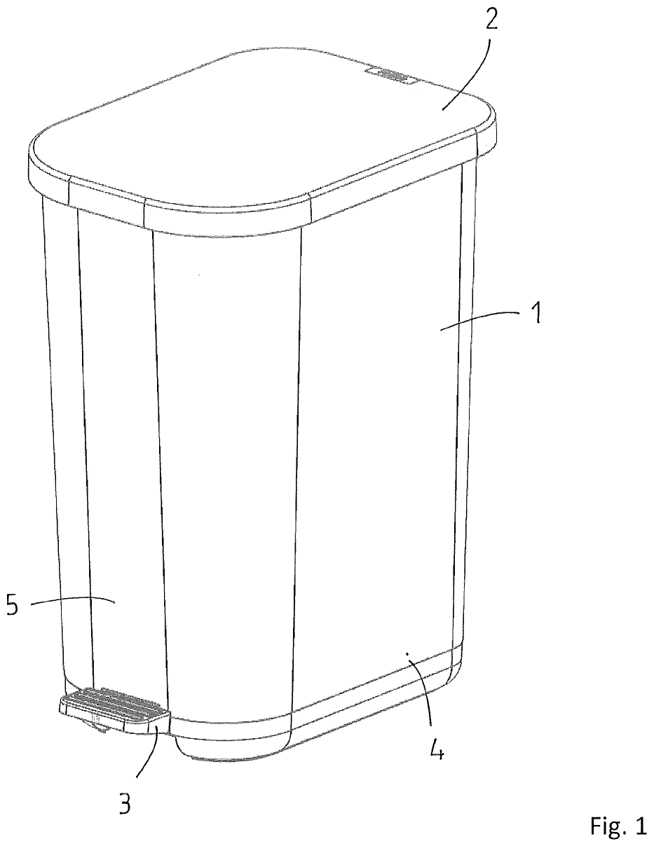

FIG. 1 shows an exemplary embodiment for a waste bin configured according to the invention in a form ready prepared for use. The waste bin has a container body 1, which is closed with a swivel lid 2. The swivel lid 2 can be opened via a pedal 3, while it closes automatically again because of gravity after the pedal 3 is released. The pedal 3 is located in a bottom region 4 of the waste bin, on the front side thereof, as is customary for waste bins with a pedal-operated swivel lid.

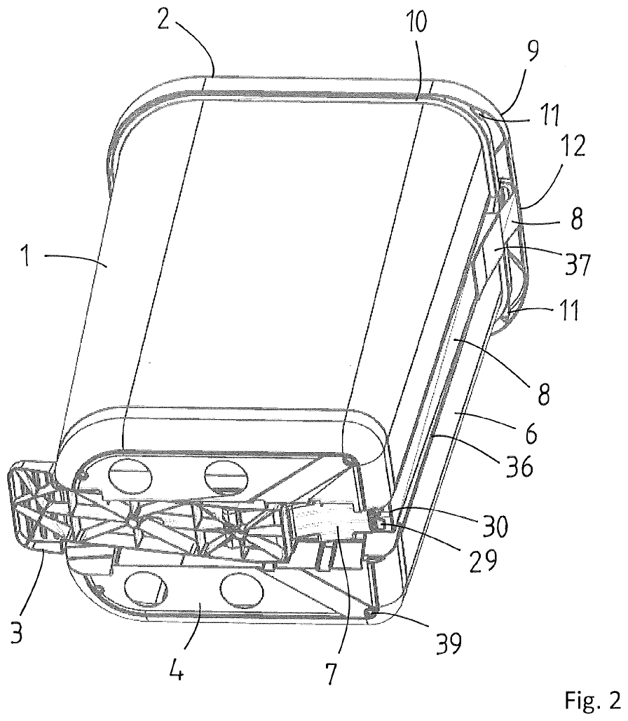

FIG. 2 shows the waste bin from FIG. 1 in a different view, such that its bottom region 4 and its rear side 6 can be seen. It can be seen here that the pedal 3 continues to the rear below the container body 1, in the bottom region 4 of the waste bin, to a rocker 7, which in turn is connected to a pull element 8 in the form of a pull strap, which ultimately acts on the swivel lid 2, on a rear side 9 thereof. The swivel lid 2 is fastened pivotably to the container body 1 in an upper edge region 10 of the container body 1 by means of a hinge 11, wherein the hinge 11 is formed from two hinge halves which are arranged in the rear corners of the upper edge region 10 of the container body 1 and are integrally formed on the container body 1 or on the swivel lid 2. The rear side 9 of the swivel lid 2 protrudes to the rear beyond the axis of the hinge 11 to a starting point 12 for the pull element 8. The rear side 9 of the swivel lid 2 is therefore pulled downward by a pull on the pull element 8 and the swivel lid 2 is thereby opened pivoting up about the hinge 11. In order to ensure stable standing of the waste bin, a total of four mounting points 39 are formed in the bottom region 4 of the container body 1, into which, for example, rubber feet can be inserted.

The pull element 8 is, as mentioned, in the form of a pull strap, which is manufactured from plastic in the present exemplary embodiment. Since the pull strap is subjected only to tensile forces, it can be very thin, as a result of which it obtains flexible properties and is guided in a groove 36 in the rear side 6 of the container body 1, and can be deflected in a guide element 37, which is in the form of a shaft and is manufactured integrally with the rear wall, for example as a protrusion thereof, toward the starting point 12 of the swivel lid. Owing to this formation, the space required by the pull element 8 is minimal and, in particular, very much smaller compared to a pull rod or even a push rod. At the same time, the pull element 8 is optimally protected in the groove 36 and in the guide element 37; it in particular also does not hinder the nesting of a plurality of waste bins for transport.

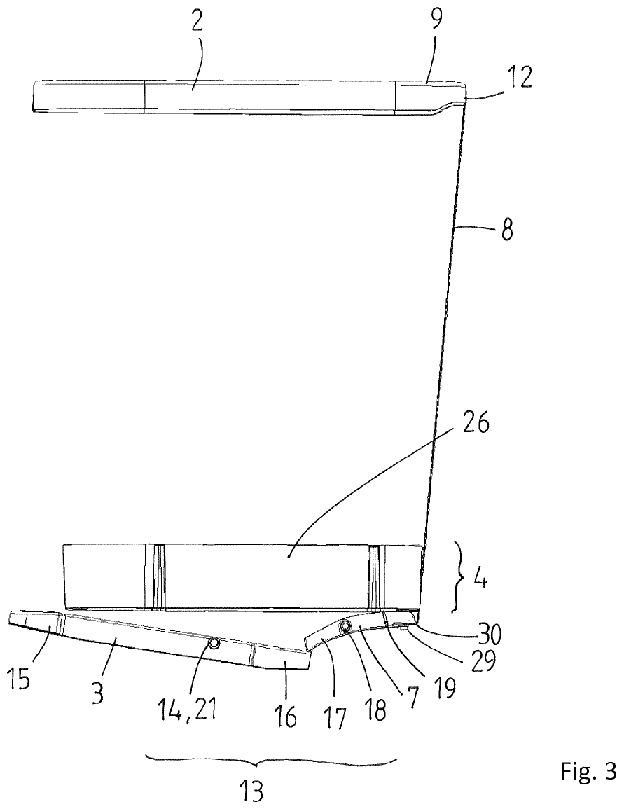

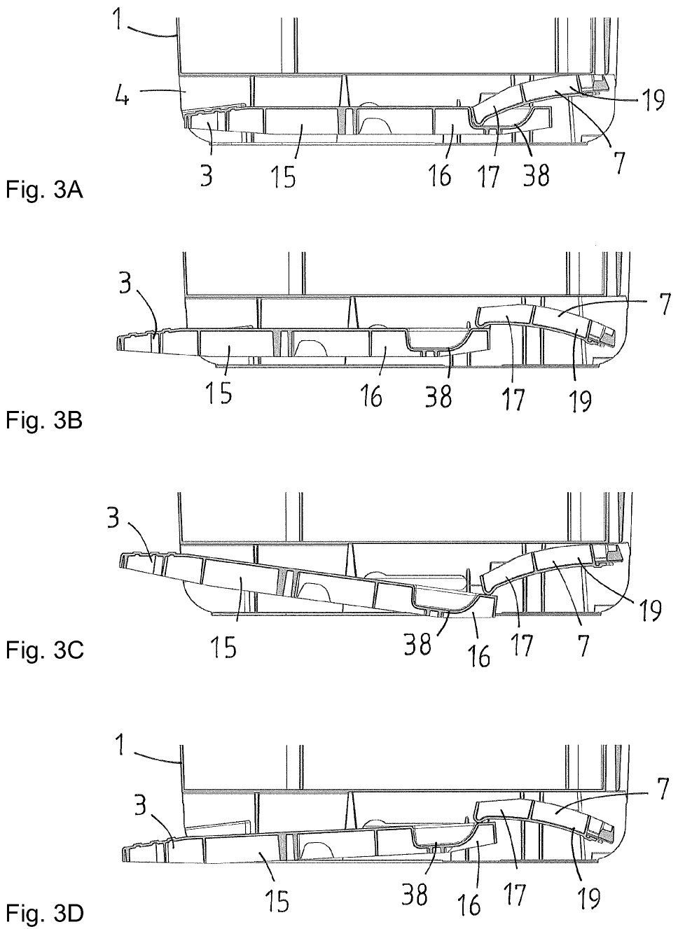

The conversion of the movement necessary for a power transmission from the pedal 3 to the swivel lid 2 is illustrated schematically in FIG. 3: the pedal 3 extends in the bottom region 4 of the waste bin to below the rocker 7 and, with the latter, forms a lever mechanism 13 for actuating the swivel lid 2 via the pull element 8. For this purpose, the pedal 3 is mounted rotatably in a pedal bearing point 14 in the manner of a rocker. The pedal bearing point 14 divides the pedal 3 into a pedal section 15 oriented toward the front side of the waste bin and an actuating section 16 oriented toward the rear side of the waste bin. Accordingly, when pedal 3 is stepped upon, the pedal section 15 moves downward, while the actuating section 16 is moved upward.

Above the actuating section 16 of the pedal 3 there is a front rocker section 17 of the rocker 7, which is mounted rotatably in a rocker bearing point 18. A rear rocker section 19 is connected to the pull element 8.

Owing to the mounting of the rocker 7 in the rocker bearing point 18, a movement of the front rocker section 17 upward leads to a movement of the rear rocker section 19 downward and thus to a pull on the pull element 8, which ultimately opens the swivel lid 2 via the starting point 12 on the rear side 9 thereof. The swivel lid 2 is closed because of its weight, with it moving the rocker 7 via the pull element 8 into the starting position shown, pressing the actuating section 16 of the pedal 3 downward via the front rocker section 17 and thus ensuring that the pedal section 15 of the pedal 3, as also shown in FIG. 1, waits in an upper standby position for the next actuation.

FIGS. 3A, 3B, 3C and 3D show, similarly to FIG. 3, various mounting and actuation states of the lever mechanism 13 in schematic sectional illustrations:

In FIG. 3A, the pedal 3 is in the first, pushed-in position in which the pedal section 15 of the pedal 3 does not protrude forward over the recess 20 or over the outer wall of the container body 1. The rocker 7, more precisely: the front rocker section 17 thereof, rests in a depression 38 in the actuating section 16 of the pedal 3. A pull element 8 fastened to the rear rocker section 19, if it were already fitted, would therefore be in a position relieved of load.

FIG. 3B shows the lever mechanism 13 when the pedal 3 is extended into its second, extended position, with an extension movement toward the front side of the container body 1. The depression 38 allows the rocker 7 to be in a position relieved of load over almost the entire extension movement and thus has sufficient clearance to allow the extension movement of the pedal 3 even if the pull element 8 had already been fastened beforehand to the rear rocker section 19. The assembly sequence (extension of the pedal 3 and fastening of the pull element 8 to the rocker 7 and to the lid 2) therefore does not have to be fixed and observed, which is a great advantage in the consumer market, where the end user performs the final assembly.

FIG. 3B strictly speaking shows only the transition from the first position of the pedal 3 to the second position, which can be seen in FIG. 3C. Owing to the shaping of the depression 38 in the manner of a slotted guide for the front rocker section 17, the latter is pressed upward only in the transition phase (FIG. 3B), while, in the second, extended position of the pedal, in which the pedal section 15 moves upward (FIG. 3C), it returns again into the inoperative position.

When the pedal 3 is stepped upon for actuating the swivel lid 2, the situation shown in FIG. 3D arises: the pedal section 15 is lowered, as a result of which the actuating section 16 of the pedal is raised, in the process carrying along the front rocker section 17 upward, as a result of which the rear rocker section 19 is lowered. This ultimately leads to the pulling movement via the pull element 8 (not illustrated here) and by means of this to the opening of the swivel lid 2 (also not illustrated here).

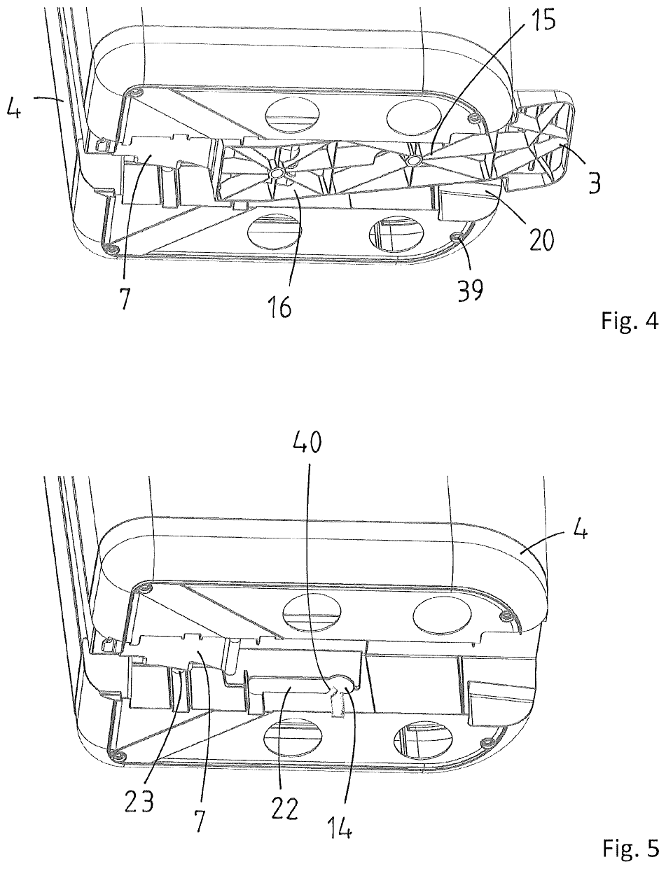

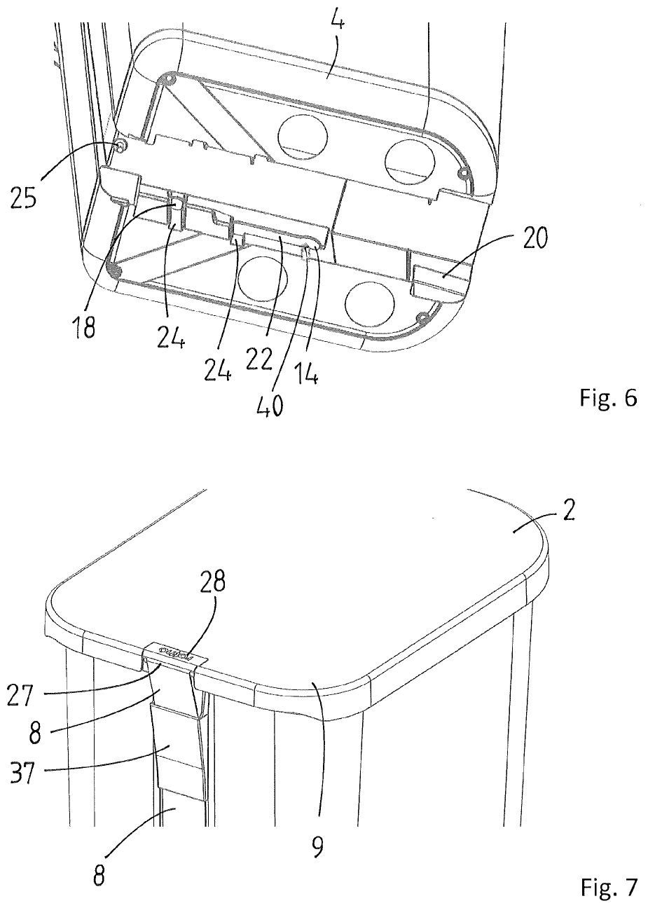

FIGS. 4 to 6 each show the bottom region 4 of the present exemplary embodiment for a waste bin according to the invention, wherein, in FIG. 4, the lever mechanism 13 is completely present, whereas, in FIG. 5, the pedal 3 is removed and, in FIG. 6, both the pedal 3 and the rocker 7 and the pull element 8 are removed.

As already indicated in FIG. 3, the pedal 3 and the rocker 7 are not fixedly connected to each other. On the contrary, the front rocker section 17 rests only loosely on the actuating section 16 of the pedal 3. Since the swivel lid 2 closes automatically because of its gravitational force, this does not lead to any impairment whatsoever of the lever mechanism 13. This only loose connection between the pedal 3 and the rocker 7, however, allows the pedal 3, as provided according to the invention, to be mounted displaced rearward to the rear side 6 of the waste bin, so that the pedal section 15 is completely received in the bottom region 4 of the waste bin (cf. FIG. 3A). The small recess 20 on the front side of the bottom region 4 is also used for this purpose.

As in particular FIG. 5 illustrates, in a second, extended position (cf. FIG. 4 and FIGS. 3C, 3D), the pedal 3 sits on both sides in a respective pedal bearing point 14, which receives the corresponding pedal bearing journals 21 which are integrally formed on the pedal 3. These pedal bearing points 14 continue in a slotted guide 22, along which the pedal bearing journals 21 of the pedal 3 can be displaced forward out of the first, pushed-in position to pull the pedal 3 forward out of the bottom region 4 to an extent until it is in the second, extended position, in order to make the waste bin usable as such.

The recess 20 is formed here in such a way that the pedal 3 can be displaced rearward in the slotted guide 22 only when the pedal section 15 has been shifted downward, i.e., the pedal 3 has been activated. The pedal 3 therefore cannot be inadvertently pushed in when the swivel lid 2 is actuated.

In a preferred embodiment, which is illustrated in the present drawings, an elastically deformable latching element 40, which is integrally formed as a catch on the bottom region 4 of the container body 1, additionally prevents the pedal 3, once it has been moved into the second, extended position, from being pushed in again, since it latches behind the pedal bearing journals 21.

In another embodiment, which is not illustrated here, the pedal bearing point 14 is provided merely with latching lugs, and therefore the pedal bearing journal 21 of the pedal 3 can be moved via a resistance from the pedal bearing point 14 into the slotted guide 22 in order to be able to move the pedal 3 again from the second, extended position into the first, pushed-in position.

The rocker 7, as shown in FIG. 5, is also provided with rocker bearing journals 23, which are mounted in rocker bearing points 18 (FIG. 6).

The rocker bearing point 18 and the slotted guide 22 and the pedal bearing point 14 formed therein are accessible from below via mounting channels 24 in order to be able to fit the rocker 7 and the pedal 3. Immediately after assembly, the pedal 3 remains in its first, pushed-in position and is displaced by the slotted guide 22 into the pedal bearing point 14, and thus moved into its second position, only prior to use.

As FIG. 6 finally also shows, a damper element 25 sits above the rear rocker section 19 (which is omitted here). This has the effect that the rear rocker section 19 can be moved upward by the pull element 8 only in a slowed down manner, i.e., in a damped manner. This ultimately damps the closing movement of the swivel lid 2 such that the latter cannot shut quickly, but rather only slowly moves back into its closed position.

In the illustration of FIG. 3 which is schematic per se, a trough-shaped insert element 26 is also shown, which is inserted into the container body 1 in the bottom region 4 of the waste bin in order to cover the lever mechanism 13. This insert element 26 can be removed and reinserted inversely oriented in order to reduce the usable volume of the waste bin and, for example, to adapt it to smaller garbage bags.

As is merely indicated in FIGS. 3 and 7, the pull element 8 of the present exemplary embodiment, which is in the form of a pull strap, is provided with film hinges 27, 30 both at its upper end and at its lower end:

An upper film hinge 27 (FIG. 7) connects the pull strap integrally with an upper latching element 28, which can be simply clipped into the rear side 9 of the swivel lid 2 in order to connect the pull strap to the swivel lid 2. In a corresponding manner, a lower latching element 29 is integrally formed on the pull strap via a lower film hinge 30, the lower latching element 29 being connected to the rear rocker section 19 by latching thereto.

Since the waste bin according to the invention works with a pull element 8, which is in the form of a pull strap, film hinges are completely sufficiently stable in order to reliably mechanically connect the lever mechanism 13 to the swivel lid 2 throughout the service life of the waste bin.

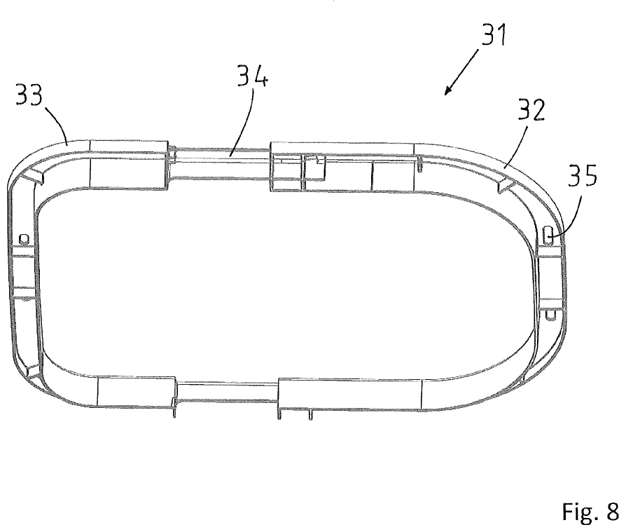

Finally, FIG. 8 shows a frame 31, as can preferably be used for hanging garbage bags (not illustrated) and as can preferably be clipped into the swivel lid 2 to be transported there. This frame 31 is composed of a front frame part 32 and a rear frame part 33, which are inserted into each other and can be moved against each other to pull the frame 31 apart or push it together such that garbage bags of differing size can be held. By means of second apertures 35, the frame 31 can be clipped onto the inside of the swivel lid 2 for transport.

The frame 31 is adjusted by means of latches provided by a rack and pinion mechanism 34. To fasten a garbage bag (not illustrated) to the frame 31, the frame 31 is first of all removed, then pushed together and the garbage bag is placed over the frame 31. Then the rear frame part 33 is moved rearward in a latching manner against the rack and pinion mechanism 34 until the frame 31 fits as precisely as possible into the hung garbage bag. Finally, the frame 31 which is adapted in this way to the garbage bag is inserted with the garbage bag into the container body 1 by the frame 31 being placed, at least with its front frame part 32, onto the upper edge region 10 of the container body 1.

### LIST OF REFERENCE SIGNS

1 Container body
2 Swivel lid
3 Pedal
4 Bottom region
Front side (of 1)
6 Rear side (of 1)
7 Rocker
8 Pull element
9 Rear side (of 2)
Upper edge region (of 1)
11 Hinge
12 Starting point
13 Lever mechanism
14 Pedal bearing point
Pedal section 36 Groove
16 Actuating section
17 Front rocker section
18 Rocker bearing point
19 Rear rocker section
20 Recess
21 Pedal bearing journal
22 Slotted guide
23 Rocker bearing journal
24 Mounting channels
25 Damper element
26 Insert element
27 Upper film hinge
28 Upper latching element
29 Lower latching element
30 Lower film hinge
31 Frame
32 Front frame part
33 Rear frame part
34 Rack and pinion
mechanism
35 Aperture
37 Guide element
38 Depression (in 16)
39 Mounting points
40 Latching element

1. A waste bin, comprising:
a container body (1),
a pedal-operated swivel lid (2),
a pedal (3) located in a bottom region (4) of the waste bin, on a front side (5) thereof, the pedal is connected via a lever mechanism (13) to a pull element (8), the pull element (8) runs on a rear side (6) of the waste bin from the bottom region (4) to a rear side (9) of the swivel lid (2) and produces an operative connection between the pedal (3) and the swivel lid (2),
the swivel lid (2) being attached via a hinge (11) to the rear side (9) of the waste bin, the hinge (11) is arranged in an upper edge region (10) of the container body (1),
and the rear side (9) of the swivel lid (2) protruding beyond an axis of the hinge (11) to the rear as far as a starting point (12) for the pull element (8), and
the pedal (3) is arranged extendably on the waste bin such that, in a first, pushed-in position, the pedal does not protrude beyond the front side (5) of the waste bin, while, in a second, extended position, the pedal protrudes beyond the front side (5) of the waste bin and is operatively connected to the lever mechanism (13) such that stepping upon the pedal (3) opens the swivel lid (2).

2. The waste bin as claimed in claim 1,
wherein the pull element (8) is composed of plastic and formed as a pull strap, and the pull element (8) is connectable to the swivel lid (2) via an upper film hinge (27).

3. The waste bin as claimed in claim 2,
wherein the pull element (8) is fixedly connected to an upper latching element (28) via the upper film hinge (27), and the upper latching element (28) is latchable in a recess provided in the swivel lid (2).

4. The waste bin as claimed in claim 1,
wherein the pull element (8) is composed of plastic and is formed as a pull strap, and the pull element (8) is connectable to the lever mechanism (13) via a lower film hinge (30).

5. The waste bin as claimed in claim 4,
wherein the pull element (8) is fixedly connected to a lower latching element (29) via the lower film hinge (30), and the lower latching element (29) is latchable in the lever mechanism (13).

6. The waste bin as claimed in claim 1,
wherein the pull element (8) is guided in a groove (36) in the rear side (6) of the waste bin.

7. The waste bin as claimed in claim 6,
further comprising a guide element (37) for guiding the pull element (8) in the groove (36) located in an upper region of the groove (36).

8. The waste bin as claimed in claim 1,
wherein the lever mechanism (13) is designed such that the pedal (3), in the second, extended position, is mounted rotatably for rocking in a pedal bearing point (14), with a pedal section (15) which is oriented from the pedal bearing position (14) to the front side (5) of the waste bin and protrudes beyond said front side, and with an actuating section (16) which is oriented from the pedal bearing point (14) to the rear side (6) of the waste bin,
and a rocker (7) is mounted rotatably in a rocker bearing point (18) for operatively connecting the pedal (3) to the pull element (8),
wherein the rocker (7) is connected in a rear rocker section (19) to the pull element (8) for carrying tension, and a front rocker section (17) is arranged above the actuating section (16) of the pedal (3) in the second position in order to be moved upward by said actuating section when the pedal section (15) is stepped upon.

9. The waste bin as claimed in claim 8,
wherein the pedal (3) and the rocker (7) are not fixedly connected to each other, and therefore the pedal (3) is moveable from the first into the second position.

10. The waste bin as claimed in claim 9,
wherein the actuating section (16) of the pedal (3) has a depression (38) for receiving the front rocker section (17) of the rocker (7) in the first, pushed-in position of the pedal (3), which depression is shaped as a slotted guide such that, when the pedal (3) is extended into the second position, the rocker (7) produces a substantially play-free operative connection between the pedal (7) and the pull element (8) and then to the swivel lid (2) only toward an end of the extension movement.

11. The waste bin as claimed in either of claim 10,
wherein the pedal (3) is moveable from the first into the second position in the slotted guide (22) arranged in the container body (1).

12. The waste bin as claimed in claim 11,
wherein the slotted guide (22) guides pedal bearing journals (21) arranged on both sides of the pedal (3) and forms the pedal bearing point (14).

13. The waste bin as claimed in claim 9,
further comprising a latching element (40) provided to prevent movement of the pedal (3) from the second, extended position back into the first, pushed-in position.

14. The waste bin as claimed in claim 13,
wherein the latching element (40) comprises an elastically deformable catch integrally formed on the slotted guide (22).

15. The waste bin as claimed in claim 1,
further comprising a trough-shaped insert element (26) that is insertable into the container body (1) for covering the lever mechanism (13).

16. The waste bin as claimed in claim 15,
wherein the trough-shaped insert element (26) sits removably in the container body (1) and is insertable in a reverse orientation into the container body (1).

17. The waste bin as claimed in claim 1, further comprising a frame (31) for hanging garbage bags in the upper edge region of the container body (1), wherein said frame (31) includes a front frame part (32) and a rear frame part (33), which are inserted into each other and are adjustable in a latching manner with respect to each other by a rack and pinion mechanism (34), and at least the front frame part (32) is placeable in a form-fitting manner onto an upper edge of the container body (1).

18. The waste bin as claimed in claim 17,
wherein the frame (31) is clipable into the swivel lid (2).

19. The waste bin as claimed in claim 1, further comprising a damper element (25) for a damped closing movement of the swivel lid (2), the damper element acts on the rocker (7) and slows down a movement thereof.

20. A waste bin, comprising:
a pedal-operated swivel lid (2),
the pedal-operated swivel lid is a single- or multi-part swivel lid (2) and is attached to a container body (1) via at least one hinge (11), arranged in an upper edge region (10) of the container body (1) of the waste bin,
a pedal (3) located in a bottom region (4) of the waste bin, on a front side (5) thereof, the pedal is connected via a lever mechanism (13) to a push rod or to a pull element (8), which runs on a rear side (6) of the waste bin from the bottom region (4) to the swivel lid (2) and produces an operative connection between the pedal (3) and the swivel lid (2),
a frame (31) for hanging garbage bags is provided in the upper edge region of the container body (1),
the frame (31) includes a front frame part (32) and a rear frame part (33) which are inserted into each other and are movable in a latching manner against each other in order to change a circumference of the frame by pulling apart or pushing together the frame parts (32, 33),
and a trough-shaped insert element (26) that is insertable into the container body (1),
the trough-shaped insert element (26) sits removably in the container body (1) and is insertable in a reverse orientation into the container body (1) in order to reduce a usable volume of the waste bin.

21. The waste bin as claimed in claim 20,
wherein the front frame part (32) and the rear frame part (33) are movable in a latching manner against each other by means-of a rack and pinion mechanism (34).

22. The waste bin as claimed in claim 20,
wherein at least the front frame part (32) is placeable in a form-fitting manner onto an upper edge of the container body (1) and is secured by at least one of pins or apertures (35).

23. The waste bin as claimed in claim 20,
the frame (31) is clipable into the swivel lid (2).
